(19) United States
(12) Patent Application Publication
(10) Pub. No.: US 2021/0184255 A1
(43) Pub. Date: Jun. 17, 2021

(54) MULTILAYER ELECTRODES AND SOLID ELECTROLYTES

(71) Applicants: FUNDACION CENTRO DE INVESTIGACION COOPERATIVA DE ENERGIAS ALTERNATIVAS CIC ENERGIGUNE FUNDAZIOA, Vitoria-Gasteiz, Alava (ES); FUNDACION TECNALIA RESEARCH & INNOVATION, Donostia-San Sebastian, Guipuzcoa (ES)

(72) Inventors: Anna LLORDES GIL, Vitoria-Gasteiz, Alava (ES); Frederic AGUESSE, Vitoria-Gasteiz, Alava (ES); Antonio GUTIERREZ PARDO, Vitoria-Gasteiz, Alava (ES); Jakub ZAGORSKI, Vitoria-Gasteiz, Alava (ES); Francisco Jose FERNANDEZ CARRETERO, Donostia-San Sebastian, Guipuzcoa (ES); Amal SIRIWARDANA, Donostia-San Sebastian, Guipuzcoa (ES); Alberto GARCIA LUIS, Donostia-San Sebastian, Guipuzcoa (ES); Haizea VILLAVERDE CENDOYA, Donostia-San Sebastian, Guipuzcoa (ES)

(21) Appl. No.: 17/268,906

(22) PCT Filed: Sep. 11, 2019
(86) PCT No.: PCT/EP2019/074214

§ 371 Date: Feb. 16, 2021

(30) Foreign Application Priority Data
Sep. 13, 2018 (EP) 18382657.7

(51) Int. Cl. H01M 10/0562; H01M 4/38; H01M 4/36; H01M 4/04

(52) U.S. Cl. CPC H01M 10/0562; H01M 4/386; H01M 2300/008; H01M 4/0414; H01M 4/0419; H01M 4/366

(57) ABSTRACT

Multilayer electrodes and/or solid electrolytes having an OIPC cover material, and solvent-free methods for preparing the multilayers, as well as solid-state full batteries having the multilayers are disclosed.

### FIELD OF THE INVENTION

This invention relates to the field of all-solid state batteries. More particularly, the invention relates to multilayer electrodes and/or solid electrolytes useful for such batteries, as well as to methods for preparing said multilayer electrodes and/or solid electrolytes.

### BACKGROUND

In recent years, numerous efforts to develop all-solid state batteries (SSBs) have been made. SSBs, which employ solid-state electrolytes (SSEs), provide potential solutions to the primary problems encountered in traditional batteries, which employ flammable liquid electrolytes, such as poor safety or energy density. Furthermore, steady progress on the improvement of ion conductivity in SSEs is attracting much attention as it has now been shown to rival the conductivity of organic electrolytes. SSBs are therefore expected to outperform current technologies, especially in the context of large-scale energy storage such as in electrical vehicle applications, where solid-state lithium batteries (SSLiBs) are of particular importance, or in grid energy storage, where solid state Na-ion batteries (SSNaBs) are noteworthy of mention.

Despite their recognized potential, SSBs currently face limitations for their successful implementation in the market. A key limitation is that, for full cell development, a stable and efficient interface with small interfacial impedance between SSEs and electrodes is critical but seldom achieved, especially at the anodes. For instance, given the fact that Li metal has the highest capacity (3860 mAh/g) and the lowest potential (−3.040 vs. standard hydrogen electrode) as an anode, achieving a stable interface between SSE and Li metal anodes is a task of particular importance.

Additionally, such SSBs should ideally perform efficiently in terms of battery cycling, in particular they should achieve homogeneous metallic electrodeposition enabling long cycle life at high current densities.

Among the most studied SSEs are garnet-structured ceramics, as they possess high Li-ion conductivity, and a high electrochemical window and chemical stability. However, the physical contact between the garnet and Li metal is poor because of the rigidity and rough surface of the ceramic material which leads to limited contact points, high interfacial resistance and mechanical fracture upon cycling with Li metal anodes.

Attempts at reducing interfacial resistance between SSEs and electrodes have been made in the prior art. For instance, WO 2016/069749 discloses coating electrodes or SSEs with a layer of a specific inorganic material such as Al₂O₃, TiO₂, V₂O₅, Y₂O₃; or with a layer of an organic polymer, e.g. perfluoropolyether (PFPE) or polyvinylidene fluoride (PVDF) based materials, or with a solvent including a lithium salt. Methods of coating employed are complex ones such as atomic layer deposition for the inorganic layers, or solvent based methods for the organic layers.

In view of the above, an impending need exists to further the development of stable and efficient SSB cells or parts thereof which materialize the recognized potential of SSBs. Furthermore, the manufacture of said cells or parts thereof should be also as efficient and as straightforward as possible in order to maximize their applicability at the industrial scale.

### BRIEF DESCRIPTION OF THE INVENTION

The present inventors have now developed multilayer structures which address the above discussed issues and are of particular interest for industry from a performance and manufacture point of view.

Thus, in a first aspect, the present invention refers to a multilayer comprising a cover material disposed on a surface selected from:
the surface of an electrode, in particular the surface of an anode; or
the surface a solid electrolyte;
   wherein the cover material comprises at least one organic ionic plastic crystal (OIPC).

The present inventors have found that such a multilayer is capable of achieving conductivities above those of prior art electrolytes or electrodes based on polymeric coatings and provides for improved cycling by withstanding high current densities before short-circuiting. The cover material of the multilayers of the invention allows reducing the poor contact and mechanical failure between the electrodes and the SSE that can result from the volume changes during battery cycling.

The present invention therefore also relates in another aspect to an electrochemical cell or battery comprising a multilayer according to the first aspect of the invention.

In addition to the surprising properties of the multilayer of the invention itself, the present inventors have also found that the preparation of the multilayer of the first aspect of the invention requires no complex deposition techniques such as those of the prior art employing high-vacuum and/or temperature (e.g. ALD, sputtering, CVD), nor is the use of solvent necessary throughout the deposition process, as is needed in solvent-based methods of the prior art. The latter is of particular importance as it eliminates potential problems of residual solvent traces in the multilayer reacting with electrode active materials or degrading a metallic anode, causing detrimental effects in the final battery performance, such as capacity fade and poor cycle life; or prevents the release of traces of absorbed solvent during cycling that often leads to system failure; or reduces the economical expenditure and environmental harm when the process is taken to an industrial scale.

The method for preparing a multilayer of the first aspect of the invention comprises the steps of:
i. heating a cover material, wherein the cover material comprises at least one organic ionic plastic crystal (OIPC), wherein the heating is to or above the melting point of the OIPC;
ii. depositing the melted cover material on a surface selected from the surface of an electrode, preferably of an anode, or the surface of a solid electrolyte.

### BRIEF DESCRIPTION OF THE DRAWINGS

FIG. 1 shows a solvent-free preparation of a complex and cell according to the present invention.

FIG. 2 illustrates Scanning Electron Microscopy micrographs of Li metal anode without OIPC coating (left) and with OIPC coating (right). A homogeneous and uniform layer of the cover material can be observed in the coated surface.

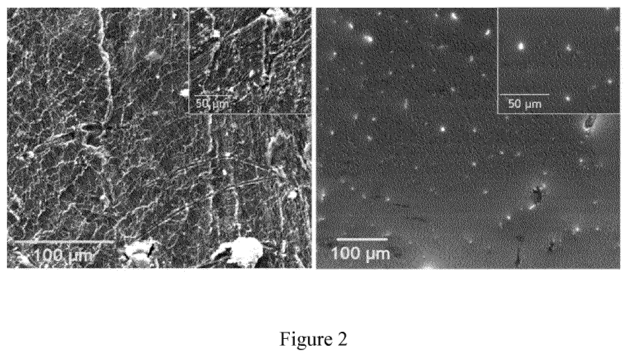

FIG. 3 shows (a) the Nyquist plot (EIS Spectrum) of the multilayer of Example 1 of the present invention at room temperature and (b) corresponding Arrhenius plots from 0 to 70° C. and from 70 to 0° C. A high ionic conductivity value of 1.9 mS·cm⁻¹ is observed for the multilayer of the invention at room temperature, increasing up to 5.5 mS·cm⁻¹ at 70° C. Two linear regions can be observed in the Arrhenius plot, revealing a change in ion transport mechanisms. The change in slope coincides with the transition phases presented in the OIPCs. Below this transition temperature, the activation energy (Eₐ) increases up to ˜1 eV indicating difficult ion mobility. However, above this temperature, the activation energy of the multilayer decreases down to ˜0.15 eV, indicating low energy barriers for Li⁺ transport in the OIPC structure.

FIG. 4 depicts the results of the Li Stripping-plating experiments of Example 3. These experiments were performed at room temperature (a) in absence and (b) in presence of the cover material.

FIG. 5 depicts the results of the Li Stripping-plating experiments of Example 3. These experiments were performed at 70° C. (c) in absence and (d) in presence of the cover material.

### DETAILED DESCRIPTION OF THE INVENTION

The present invention refers to a multilayer comprising a cover material disposed on a surface selected from:
the surface of an electrode; or
the surface of a solid electrolyte;
   wherein the cover material comprises at least one organic ionic plastic crystal (OIPC).

Although molecular plastic crystals have been known since the 1960s, the practical relevance of plasticity in organic ionic materials is a more recent discovery and is for example discussed in Cooper and Angell, Solid State Ionics, 1986, 18-19 (part 1), 570-576.

As opposed to ionic liquids, OIPCs are characterized by possessing different crystal structures as a function of temperature, wherein a higher-temperature crystal structure or structures exhibit soft, plastic mechanical properties and significant ion mobility. These crystal structures are known as the rotator phase. Hence, in the context of the present invention, an OIPC is an organic ionic species which presents one or more solid-solid phase transitions which lead to an enhanced, or at least doubled, or at least tripled, level of molecular rotation in the higher temperature solid phase with respect to the lower temperature solid phase. These molecular rotations originate in rotational motions of one or both of the ions in the OIPC; in other words, the ions can exhibit some of the motional properties that are characteristic of the liquid without losing their three-dimensional ordered structure.

OIPCs comprise at least one organic ion, which may be an anion or a cation. In the context of the present invention, an organic ion possesses the meaning generally recognized in the field of the invention, and in particular, it refers to ions which comprise C, H, O, N, S, P, Se or B. Typical organic anions include trifluoromethane sulfonimide (also known as bis (trifluoromethane) sulfonimide, TFSI, [(CF₃SO₂)₂N]⁻), fluorosulfonylimide (also known as bis (fluorosulfonyl) imide (FSI; [FSO₂)₂N]⁻) or SCN⁻, whereas typical organic cations include cations of nitrogen-containing heterocycles or quaternary ammonium compounds. In an embodiment, both the anion and the cation of the OIPC are an organic ion.

In an embodiment of the invention, an OIPC is a species as described above wherein the entropy of fusion ΔS_{fus} from the highest temperature solid phase to the melt is below 20 J K⁻¹ mol⁻¹.

Solid-solid phase transitions, as well as solid-melt transitions of OPICs may be detected by Differential Scanning Calorimetry (DSC). In particular, the enthalpy of fusion ΔH_{fus} can be calculated from DSC curves, and in turn, allows determining the entropy of fusion according to the following equation:

$$Δ {S}_{fus} = \frac{Δ {H}_{fus}}{{T}_{f}}$$

wherein T_{f} is the melting point. In the context of the present invention, ΔH_{fus} and ΔS_{fus} can be calculated according to ASTM E793-06 (2018).

Similarly, the skilled person knows how to determine in each case and with these methods whether solid-solid transitions in an OIPC are affected by the different possible components of the cover material as described below or by their amounts in the cover material.

In the context of the present invention, a “multilayer” is used as a general term to embrace a structure comprising a first layer covered or coated, partially or fully, by at least another layer. The first layer is the electrode or the SSE. The second layer is the cover material. Hence, in its simplest form wherein only one coating layer of cover material is disposed on the electrode or the SSE, the multilayer is a bilayer. However, the bilayer may be coated again with cover material to yield a multilayer which is a trilayer, and so forth.

Therefore, a multilayer according to the present invention can be:

An electrode, preferably an anode, comprising a cover material disposed on a surface of said electrode, wherein the cover material comprises at least one organic ionic plastic crystal (OIPC); or

A SSE comprising a cover material disposed on a surface of said SSE, wherein the cover material comprises at least one OIPC; or

A complex formed by a SSE and an electrode, preferably an anode, comprising a cover material disposed in between a surface of said SSE and a surface of said electrode, wherein the cover material comprises at least one OIPC.

Examples of suitable layers are films, sheets or foils.

In a preferred embodiment, the OIPC comprises a cation selected from:
a) An ammonium cation (NR₄⁺), a phosphonium cation (PR₄⁺), or a sulfonium cation (SR₃⁺)
   wherein each R is independently hydrogen; C₁-C₃₀, preferably C₁-C₆ alkyl group; C₂-C₃₀, preferably C₂-C₆ alkenyl group; or C₂-C₃₀, preferably C₂-C₆ alkynyl group;
      wherein the alkyl, alkenyl or alkynyl groups may be unsubstituted or substituted with halogen (e.g. F, Cl, Br or I) or a hydroxyl group;
      wherein the alkyl, alkenyl or alkynyl groups may be branched or linear. In an embodiment, each R group is identical.
b) A heterocyclic cation, i.e. a heterocycle which bears a positive charge at any of its heteroatoms. “Heterocycle” refers to a stable 3- to 15 membered ring radical which consists of carbon atoms and from one to five heteroatoms selected from the group consisting of nitrogen, oxygen, and sulfur; the ring radical may be aromatic or non-aromatic, and may be monocyclic, bicyclic or tricyclic, which may include fused ring systems. Suitable heterocyclic cations include pyrrolidinium, imidazolium, pyrazolium, piperazinium, or diazepanium. Preferably, a heteroatom of the basic (non-cationic) heterocycle (Het) is substituted with an R group to yield the cationic heteroatom/heterocycle (Het⁺-R), wherein R is as described immediately above. For instance, an N atom in the heterocycles may be quaternized to give the heterocyclic cation.

More preferably, the OIPC comprises a cation selected from a phosphonium cation or a pyrrolidinium cation as they are described above, even more particularly a phosphonium cation. A pyrrolidinium cation as described above is hence of the structure (R)₂-pyrrolidinium, wherein each R is as described above and is bonded to the nitrogen atom of the pyrrolidine ring. Examples of suitable particular phosphonium cations are diethyl(methyl)(isobutyl)phosphonium, methy(triethyl)phosphonium, triisobutyl(methyl)phosphonium, or triethyl(methyl)phosphonium. Examples of suitable particular pyrrolidinium cations are N-ethyl-N-methyl-pyrrolidinium or N,N-dimethylpyrrolidinium. In a most preferred particular embodiment, the OIPC comprises the triisobutyl(methyl)phosphonium cation.

In a preferred embodiment, the OIPC comprises an anion selected from BF₄⁻, PF₆⁻, SCN⁻, I⁻, nitrate, phosphate, or a sulfonate or sulfonylimide of the following formula:

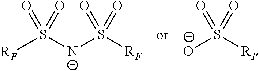

wherein each R_{f} is independently F; C₁-C₃₀, preferably C₁-C₆ alkyl group; C₂-C₃₀, preferably C₂-C₆ alkenyl group; or C₂-C₃₀, preferably C₂-C₆ alkynyl group; wherein the alkyl, alkenyl or alkynyl groups are fully or partially, preferably fully, substituted with F;
wherein the alkyl, alkenyl or alkynyl groups may be branched or linear; and wherein each R_{f} group is preferably identical.

Preferably, the anion is a sulfonate or sulfonylimide as described above.

In a preferred embodiment, the R_{f} group is —CF₃, —CF₂CF₃, —CF₂CF₂CF₃ or —CF₂CF₂CF₂CF₃. More preferably, the OIPC comprises an anion selected from FSI or TFSI, even more preferably FSI.

Each of the above described cation types and cations may be combined with each of the above described anion types and anions to arrive at further particular OIPCs. In a preferred embodiment, the OIPC comprises at least an organic cation and at least an organic anion, which are preferably selected from those described above. In an especially preferred embodiment, the OIPC comprises a phosphonium cation as described above and a sulfonylimide anion as described above, such as triisobutyl(methyl)phosphonium and FSI, or triisobutyl(methyl)phosphonium and TFSI.

The cover material of the present invention is the material which is employed to cover or coat the surface of an electrode or of a solid electrolyte. This covering or coating with the specific cover material of the invention enables intimate physical contact (good wettability) between electrode and electrolyte and aids diminishing interfacial resistance (ASR).

The cover material consists of the OIPC, or the cover material comprises the OIPC in an amount of at least 30% by weight, at least 35% by weight, at least 40% by weight, at least 45% by weight, at least 50% by weight, at least 55% by weight, at least 60% by weight, at least 65% by weight, at least 70% by weight, at least 75% by weight, at least 80% by weight, at least 85% by weight, at least 90% by weight, at least 95% by weight, or at least 99% by weight with respect to the total weight of the cover material. Preferably, the cover material comprises the OIPC in an amount of at least 30% by weight with respect to the total weight of the cover material. Particularly, the cover material comprises the OIPC in an amount of more than 40%, such as more than 50%, or even such as more than 90%, by weight with respect to the total weight of the cover material. Where the cover material comprises the OIPC, the cover material may comprise at least one additional component in addition to the OIPC. Examples of suitable additional components are ionic liquid materials, polymers, dopants and inorganic fillers.

In an embodiment, the additional component is an ionic liquid material. The skilled person knows, based on the above described methods, which materials constitute ionic liquids, and which constitute OIPCs. An ionic liquid (not being an OIPC) will typically have an entropy of fusion ΔS_{fus} from the solid phase or from the highest temperature solid phase to the melt of above, usually far above, 20 J K⁻¹ mol⁻¹.

The ionic liquid may be selected from compounds comprising a cation selected from triazole, sulfonium, oxazolium, pyrazolium, ammonium, pyridinium, pyrimidinium, pyrrolidinium, imidazolium, pyridazinium, piperidinium, phosphonium, and an anion selected from BF₄⁻, PF₆⁻, AsF₆⁻, SbF₆⁻, AlCl₄⁻, HSO₄⁻, ClO₄⁻, CH₃SO₃⁻, CF₃CO₂⁻, (CF₃SO₂)₂N⁻, (FSO₂)₂N⁻, Cl⁻, Br⁻, I⁻, SO₄⁻, CF₃SO₃⁻, (C₂F₅SO₂)₂N⁻, and (C₂F₅SO₂)(CF₃SO₂)N⁻.

In different embodiments, the ionic liquid is present in an amount of less than 30%, or less than 25%, or less than 20%, by weight with respect to the total weight of the cover material. More particularly, it is present in an amount of from 0.1 to 30%, or from 1 to 30%, or from 5 to 30%, by weight with respect to the total weight of the cover material. Alternatively, it is present in an amount of from 0.1 to 25%, or from 1 to 25%, or from 5 to 25%, by weight with respect to the total weight of the cover material. Preferably, it is present in an amount of from 0.1 to 20%, or from 1 to 20%, or from 5 to 20% by weight with respect to the total weight of the cover material.

In an embodiment, the additional component is a polymer, more preferably a polymeric electrolyte. As mentioned above, polymers have been employed in the prior art as electrode or solid electrolyte interfacial layers. Suitable polymeric electrolytes are fluoropolymers, such as polyvinylidene fluoride (PVDF) or perfluoropolyethers (PFPE); alkylene oxide polymers, such as poly(ehtylene oxide), poly(propylene oxide), or poly(probutylene oxide); siloxane polymers; or acrylate polymers.

In an embodiment, when present, the polymer is present in an amount of from 0.1 to 25%, more particularly of from 0.1 and 5%, by weight with respect to the total weight of the cover material.

However, as already explained, the cover material of the present invention does not require such polymers in order to achieve improved ASR and ionic conductivity. Thus, in a preferred embodiment of the invention, the cover material does not comprise any of the above recited polymeric electrolytes, and more particularly the cover material does not comprise alkylene oxide polymers, such as poly(ehtylene oxide), polypropylene oxide), or poly(probutylene oxide). An alkylene oxide polymer is a polymer comprising an alkylene oxide skeleton with alternating alkylene and ether oxygen groups. In another particular embodiment, the cover material does not comprise a polymer, such as a fluoropolymer as described above, which has a melting point above 170° C., such as PVDF.

In an embodiment, the additional component is a dopant. Dopants are substances which are added to the cover material in order to ensure that an appropriate concentration of charge carrier ions are available for charge conduction in the electrochemical system. In the context of the present invention, examples of suitable dopants are metal salts wherein the cation is a charge carrying metal such as Li, Na, K, Rb, Cs, Mg, Ca, Sr or Ba. Preferably, the anion is the same anion or an ion of similar properties to an anion already present in the cover material, e.g. in the OIPC or in the ionic liquid. Anions of similar properties are for example FSI and TFSI. In a preferred embodiment the dopant is selected from M(TFSI) or M(FSI) wherein M is Li, Na, K, Rb, Cs; or M(TFSI)₂ or M(FSI)₂ wherein M is Mg, Ca, Sr or Ba. In particularly preferred embodiment, the charge carrier is Li and the dopant is Li(TFSI) or Li(FSI). It has been observed that such dopants increase conductivity and help to reduce the temperature of the phase transitions in the OIPC.

In an embodiment, the dopant is present in an amount of from 0.1 to 50%, more particularly of from 0.1 to 20%, even more particularly of from 1 to 10%, by weight with respect to the total weight of the cover material.

In an embodiment, the additional component is an inorganic filler.

In an embodiment, the inorganic filler is an active filler. The term “active” indicates that the filler is involved in ionic conduction. Examples of active inorganic fillers are oxides such as Li₃ₓLa_{2/3-x}TiO₃, Li₇La₃Zr₂O₁₂ and substituted compounds with Al, Ga, Ba, Ta, Nb; sulphides such as Li₃PS₄, Li₁₀GeP₂S₁₂, Li₄GeS₄, Li₇P₃S₁₁; hydrides such as Li₂B₁₂H₁₂, LiBH₄—LiI; oxyhalides such as Li₂(OH)_{0.9}F_{0.1}Cl; nitrido-based fillers; phosphates such as Li₃PO₄, LATP, LiZr₂(PO₄)₃.

In an embodiment, the inorganic filler is an inactive or passive filler. The term “inactive” indicates that the filler is not involved in ionic conduction, but provides some other type of beneficial physical property to the electrode or solid electrolyte such as enhanced mechanical properties. Examples of inactive fillers are inert metal oxides such as TiO₂, ZrO₂, Al₂O₃; SiO₂; zeolites; rare earth oxides such as cerium oxide (CeO₂), SrBi₄Ti₄O₁₅, La_{0.55}Li_{0.55}TiO₃; ferroelectric materials such as BaTiO₃; solid superacids such as sulphates and phosphates, e.g. SO₄²⁻/ZrO₂, SO₄²⁻/Fe₂O₃, SO₄²⁻/TiO₂; ceramics such as calcium carbonate or calcium aluminates, fly ash, mica, montmorillonite; carbon, e.g. carbon nanotubes; heteropolyacids such as silicotungstic acid, phosphotungstic, molybdophosphoric, phosphomolibdicacid.

In an embodiment, the inorganic filler is present in an amount of from 0.1 to 50%, more preferably 5 to 20%, by weight with respect to the total weight of the cover material.

It is to be understood that when different components are present in the cover material, their percentages are selected so as to total 100% wt.

In a preferred embodiment, the additional components are at least one ionic liquid and at least one dopant as described in any of the above embodiments.

In a particularly preferred embodiment, the cover material comprises triisobutylmethylphosphonium bis (fluorosulfonyl) imide (OIPC), triisobutylmethylphosphonium bis (trifluoromethane) sulfonimide (ionic liquid) and LiTFSI.

The present disclosure provides a cover material disposed on, i.e. in physical contact with, a surface of an electrode or SSE. In other words, at least a portion of or a surface of or all of the surfaces of an SSE or electrode is in contact with the cover material.

In an embodiment, at least a portion of or a surface of or all of the surfaces of an SSE is in contact with the cover material. In another embodiment, at least a portion of or a surface of or all of the surfaces of an electrode, preferably the anode, is in contact with the cover material.

Preferably, in an embodiment, at least a portion of, or preferably the whole of the surface of the SSE which faces the electrodes is in contact with the cover material. More preferably, at least a portion of, or preferably the whole of the surface of the SSE which faces the anode is in contact with the cover material.

When a cover material is disposed on at least a portion of or the whole of both the surface of the SSE which faces the anode and the surface of the SSE which faces the cathode, the cover material at each said surfaces may be the same or different. Similarly, when a cover material is disposed on both an anode and a cathode, the cover material at each said electrodes may be the same or different.

The cover material is preferably disposed on the surface of the SSE or electrode in the form of a layer, preferably a continuous layer that covers the whole of a surface of the SSE or electrode. The thickness of the layer can range from 0.01 to 100 μm, preferably from 0.05 to 50 μm, more preferably from 0.1 to 10 μm. This thickness is measured perpendicularly from the SSE or electrode surface on which the cover material is disposed.

The SSE of the invention is also herein referred to as the solid electrolyte, or simply the electrolyte.

In an embodiment, the SSE comprises or is made of a material selected from ceramics, such as garnets, more particularly cubic garnets, e.g. Li₇La₃Zr₂O₁₂, or such as β-aluminas, e.g. Li-β-alumina; perovskites, such as Li_{3.3}La_{0.56}TiO₃; argyrodites, such as Li₆PS₅Cl; sulfides, such as Li₂S—P₂S₅; hydrides, such as metal hydrides, such as LiBH₄; halides, such as metal halides, such as LiI; NASICONs, such as LiTi₂(PO₄)₃, Na₃Zr₂(SiO₄)₂(PO₄); LISICONs, such as Li₁₄Zn(GeO₄)₄; borates, such as Li₂B₄O₇; and phosphates, such as metal phosphates, such as Li₃PO₄. The SSE preferably comprises or is made of an inorganic material. In a particularly preferred embodiment, the SSE comprises or is made of a garnet, more preferably a lithium garnet, and even more preferably the garnet is Li₇La₃Zr₂O₁₂, also known as LLZO.

Examples of lithium garnets include Li₅-phase lithium garnets, e.g., Li₅La₃M¹₂O₁₂, where M¹ is Nb, Zr, Ta, Sb, or a combination thereof; Li₆-phase lithium garnets, e.g. Li₆DLa₂M³₂O₁₂, where D is Mg, Ca, Sr, Ba, or a combination thereof and M³ is Nb, Ta, or a combination thereof; and Li₇-phase lithium garnets, e.g., cubic Li₇La₃Zr₂O₁₂ and Li₇Y₃Zr₂O₁₂.

In an embodiment, the SSE comprises or consists of a material which can interact electronically with electroactive ions, such as Li ions, which travel from one electrode to the other. This material allows the electroactive ions to travel through it and cross it. Thus, for example, electroactive ions travelling from the anode to the cathode must first travel through the cover material layer, and then through the SSE layer.

In an embodiment, the SSE does not comprise PVDF.

In an embodiment, the SSE layer and/or the anode layer is not in particulate form, more specifically it is not a particle or grain of particles with no dimension sized 1000 nm or greater, such as 350 nm or greater.

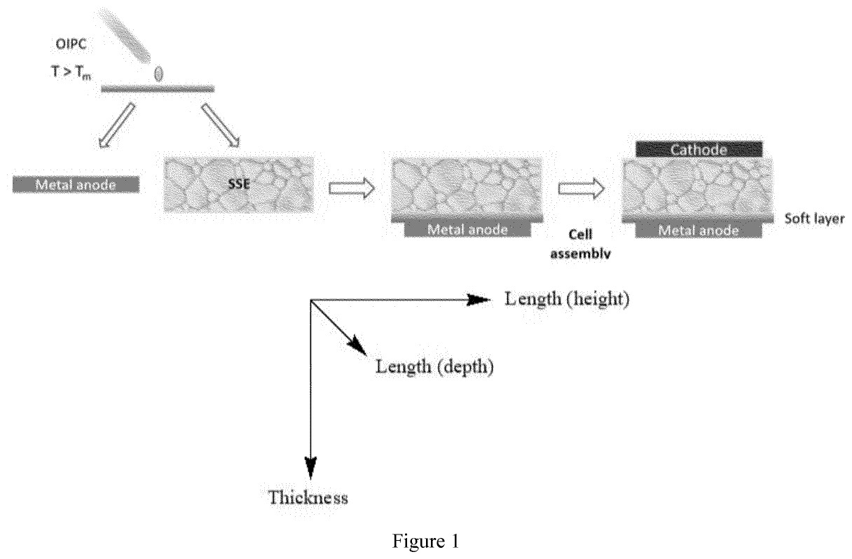

The length of a layer refers to a plane of the layer which is parallel to (and therefore does not cross) the other layers. The thickness of a layer refers to the plane perpendicular to the other layers. This is graphically depicted in FIG. 1. In an embodiment, the term layer refers to a structure wherein its length is at least two fold greater, preferably at least five fold greater, and most preferably at least ten fold greater, to its thickness. In a particular embodiment, the length is the height of the layer; preferred heights range from about 500 nm to about 30 m, more preferably from about 0.5 cm to about 30 m. In another particular embodiment, the length is the depth, preferred depths range from about 500 nm to about 30 cm, more preferably from about 0.5 cm to about 30 cm. In an embodiment, both these height and depth ranges are met. Thus, the length dimensions may adopt a geometry suitable for use in batteries of different shapes, such as for example button-shaped (i.e. substantially flat and round or oval surface), rectangular, cylindrical or prismatic geometries. In an embodiment, the length of the SSE or electrode layer corresponds to the length of the whole SSE or anode structure (of the electrochemical cell), or it corresponds to at least 50%, preferably at least 70% or more preferably at least 90% of the length of the whole SSE or anode structure (of the electrochemical cell),In an embodiment, at least 50%, preferably at least 70%, more preferably at least 90% of the volume of the cover material is not found in the form of a composite with the SSE or the anode. Conversely, in a different embodiment, at least 50%, preferably at least 70%, more preferably at least 90% of the volume of the electrode is not found in the form of a composite with the cover material. Similarly, in another embodiment, at least 50%, preferably at least 70%, more preferably at least 90% of the volume of the SSE is not found in the form of a composite with the cover material. More particularly, the cover material preferably does not penetrate the entire thickness of the electrode or SSE layer, but only e.g. at most 50%, at most 30% or at most 10% of said thickness.

The electrode which is coated/covered according to the present invention is an anode or a cathode. In a preferred embodiment, the electrode is an anode, more preferably a metallic anode.

Examples of suitable anodes are metal anodes, such as Na, Li, Zn, Mg, Al, or alloys thereof, e.g. with Al, Bi, Cd, Mg, Sn, Sb or In; or hexagonally or rhombohedrally packed carbon materials, such as graphite; or Si-based anodes such as alloys of Si with alkali metals, alkaline earth metals or transition metals, e.g. Mg₂Si, CaSi₂, NiSi, FeSi, CoSi₂, FeSi₂ and NiSi₂. Particularly preferred are Li metal anodes and anodes comprising Li alloyed with Al, Bi, Cd, Mg, Sn, or Sb, In, such as Li—Al. More preferably, the anode is a Li metal anode.

Examples of suitable cathodes are lithium metal oxides, more particularly lithium transition metal oxides, such as lithiated nickel, cobalt, chromium and/or manganese oxides, e.g. LiNi_{0.5}Mn_{0.5}O₂, Li_{1.2}Cr_{0.4}Mn_{0.4}O₂ or LiNiCoMnO₂, and more particularly lithium manganese oxide spinels, e.g. LiMn₂O₄, or layered lithium manganese oxides, e.g. Li₂MnO₃; lithium sulfides, such as Li₂S; sodium-based cathodes such as NaV_{0.92}Cr_{0.08}PO₄F, NaV_{0.96}Cr_{0.04}PO₄F, or NaVPO₄F; olivines, such as LiFePO₄; or air.

When electrodes and electrolyte are assembled to form an electrochemical cell or half-cell, the cover material disposed on the surface of the SSE comes into contact with the electrode or electrodes, preferably the anode. Similarly, if the cover material is disposed on the surface of the electrode or electrodes, preferably the anode, the cover material will come into contact with the SSE.

Thus, in a preferred embodiment, the present invention refers to an electrode-SSE multilayer complex comprising:
an electrode, preferably an anode, which presents a surface that faces a SSE;
the SSE, which presents a surface that faces the electrode, preferably the anode;
a cover material disposed between (i.e. in contact with) both surfaces;
   wherein the cover material comprises at least one organic ionic plastic crystal (OIPC).

In another embodiment, the multilayer complex comprises:
an anode, which presents a surface that faces a SSE;
a cathode, which presents a surface that faces a SSE;
the SSE, which presents a first surface that faces the anode, and a second surface that faces the cathode;
a cover material disposed either between said surface of the anode and said first surface of the SSE, and/or between said surface of the cathode and said second surface of the SSE, preferably between said surface of the anode and said first surface of the SSE;
   wherein the cover material comprises at least one organic ionic plastic crystal (OIPC).

All embodiments described above to the multilayer apply to this electrode-SSE multilayer complex.

In a particularly preferred embodiment, the cover material disposed on the surface of the electrode and/or electrolyte in the multilayer or complex of the present invention comprises no solvent. In another embodiment, it comprises at most 5% wt water, or at most 1% wt water, or at most 0.1% wt water with respect to the total weight of the cover material, but comprises no further solvent.

In a particularly preferred embodiment, the multilayer or complex of the present invention comprises no solvent. In another embodiment, it comprises at most 5% wt water, or at most 1% wt water, or at most 0.1% wt water with respect to the total weight of the multilayer or complex, but comprises no further solvent.

This is because, as described further below, the method of preparing a multilayer disclosed herein requires no solvent in any of its preparation steps, and more particularly in the cover material deposition step. Examples of solvents are aromatic hydrocarbons, such as toluene or xylene; aliphatic hydrocarbons such as diethyl ether, heptane, pentane, hexane, cyclohexane; chlorinated hydrocarbons such as ethylene dichloride, dichloromethane, trichlorethylene; ketones such as acetone; esters such as ethyl acetate; alcohols such as methanol, ethanol, propanol or butanol.

As explained above, this is particularly advantageous for ensuring proper functioning of the cell or battery comprising the multilayer or complex and also from the environmental point of view.

The present invention is also directed to a half-cell, cell or battery (SSB) comprising the multilayer or multilayer complex of the invention of any of the embodiments described herein.

The half-cell or cell further comprises a cathode-side current collector, such as Al foil, and/or an anode-side current collector, such as Cu.

The battery can comprise a plurality of said cells, in particular where each adjacent pair of said cells is separated by a separator, which can be a bipolar plate.

In an embodiment, the SSB of the invention is a lithium metal battery; a lithium-ion battery; a lithium-sulfur battery; a sodium metal battery; a sodium-ion battery; a metal-air battery, wherein the metal is selected from Li, Na, K, Zn, Mg, Ca, Al or Fe, more preferably from Li, Na or Zn, and even more preferably the metal is Li. In a preferred embodiment, the SSB is a lithium-ion battery or a lithium metal battery, more preferably a lithium metal battery.

The present invention is also directed to the use of the multilayer, complex, half-cell, cell or battery for energy storage in an electronic article such as computers, smartphones, or portable electronics (e.g. wearables); in a vehicle such as automobiles, aircrafts, ships, submarines or bicycles; or in an electrical power grid such as those associated to solar panels or wind turbines.

In a preferred embodiment, the use is at a temperature at which the OIPC in the cover material is in its “rotator” phase as described above. This temperature can be determined by different methods such as DSC, e.g. ASTM E793-06 (2018).

In another aspect, the present invention relates to a method for preparing a multilayer of the invention as described in any of the embodiments disclosed herein, the method comprising the steps of:
i. heating the cover material, wherein the cover material comprises at least one organic ionic plastic crystal (OIPC), wherein the heating is to or above the melting point of the OIPC;
ii. depositing the melted cover material on the surface of the electrode or the surface of the solid electrolyte.

As already mentioned, the method of the invention does not require the use of any solvent for achieving deposition of the melted cover material. Thus, in a preferred embodiment, the method for preparing a multilayer of the invention is carried out in the absence of solvent.

In a preferred embodiment, the heating of the cover material is to a temperature which is below the melting point of the surface on which the melted OIPC cover material is to be deposited (i.e. the anode, cathode or SSE). In other words, the cover material is preferably one in which an OIPC melts at a temperature below the melting point of the surface. This ensures that no adverse reactions between cover material and the surface take place and that a homogeneous coating is achieved. For instance, where the cover material is disposed on a lithium anode, the cover material is preferably one in which an OIPC melts at below 180.5° C.

In an embodiment, the depositing step is carried out by spin coating, spray coating, screen printing, dip coating or inkjet printing, preferably by spin coating.

In an embodiment, the surface of the electrode and/or SSE onto which the melted OIPC cover material is deposited is at a temperature below that of the melted OIPC cover material, e.g. it is at room temperature (20-25° C.).

After deposition, the deposited melted cover material is allowed to cool down below the melting point of the OIPC to achieve solidification of the cover material. The thickness of the cover material deposited on the surface of the electrode or SSE can be varied based on the choice of deposition technique and conditions employed for the chosen technique. In an embodiment, the multilayer of the present invention is a multilayer obtained by the method of the present invention as described in any of the embodiments described herein. In order to prepare the multilayer complex of the present invention, the multilayer of the invention is then brought into contact with the surface of the electrode, when the multilayer comprises the SSE; or it is brought into contact with the surface of the SSE, when the multilayer comprises the electrode.

Alternatively, the same melted OIPC cover material, i.e. the cover material in which the OIPC is still meted, can be applied to both the electrode and SSE, e.g. by bringing both the SSE and electrode into contact with the same melted OIPC cover material.

The complex of the invention is then assembled with the remaining electrode, and optionally also the current collectors, in order to arrive at the cell of the invention, as depicted in FIG. 1. In a preferred embodiment, the complex of the invention comprises the anode, and the complex is then brought into contact with the cathode. A separator is not necessary as the multilayer itself acts as the separator.

In a preferred embodiment, the electrode or SSE onto which the melted OIPC cover material is deposited is not in particulate or granular form as defined above, but is already in the form of a layer.

Lastly, cells of the invention can be assembled together to prepare a battery according to the present invention. The cells may be assembled in parallel or in series, or both. In an embodiment, any, several or each of the cells is connected to a module for monitoring cell performance, e.g. for monitoring cell temperature, voltage, charge status or current. Methods of battery assembly are well-known in the art and are reviewed for instance in Maiser, Review on Electrochemical Storage Materials and Technology, AIP Conf. Proc. 1597, 204-218 (2014).

In a preferred embodiment, in any of the embodiments disclosed herein, the electrode is a lithium (metallic lithium) anode and the SSE is a garnet. Further, in a more particular embodiment, the OIPC comprises a phosphonium cation and a sulfonylimide anion as described herein, preferably, the phosphonium cation is triisobutyl(methyl)phosphonium and the anion is FSI. Further, in a more particular embodiment, the cover material comprises an ionic liquid and a dopant as described herein, preferably the ionic liquid is triisobutyl(methyl)phosphonium TFSI and the dopant is LiTFSI.

### EXAMPLES

### Example 1—Preparation of a Cover Material and Cell According to the Present Invention

A cover material was prepared by mixing triisobutylmethylphosphonium bis (fluorosulfonyl) imide (85% wt), triisobutylmethylphosphonium bis (trifluoromethane) sulfonimide (10% wt) and LiTFSI (5% wt).

Triisobutylmethylphosphonium bis (fluorosulfonyl) imide (P₁₄₄₄FSI) was synthetized as follows: 30 g of triisobutylmethylphosphonium tosylate (Iolitec, Product number: IN-0011-TG, CAS Nr.: 344774-05-6) were dissolved in 500 mL of distilled water and stirred overnight. Then, 21 g of potassium bis (fluorosulfonyl) imide (Iolitec AQ-0022-0100) were added forming a white precipitate. The solid was filtered and washed several times with distilled water and finally dried under vacuum at 100° C.

For the synthesis of triisobutylmethylphosphonium bis (trifluoromethane) sulfonimide (P₁₄₄₄ TFSI), 30 g of triisobutylmethylphosphonium tosylate (Iolitec, Product number: IN-0011-TG, CAS Nr.: 344774-05-6) were dissolved in 500 mL of distilled water and stirred overnight. Then, 27 g of lithium bis (trifluoromethane) sulfonimide (SigmaAldrich, Product number: 15224, CAS Nr: 90076-65-6) were added forming again a white precipitate. The solid was filtered and washed several times with distilled water and finally dried under vacuum at 100° C.

(P₁₄₄₄FSI) and (P₁₄₄₄TFSI) were then mixed by melting both at 50° C. and stirred overnight in an Ar filled gloved box.

For the electrochemical testing, 5% wt. LiTFSI was added to the mixture of (P₁₄₄₄FSI) and (P₁₄₄₄TFSI) in an Ar filled glove box, in order to have conductivity in the material as well to decrease the phase temperatures. The addition was carried out at 50° C. to ensure that (P₁₄₄₄FSI) was in the liquid form. The thus produced cover material was maintained at or heated to 50° C. to obtain a cover material liquid, which was deposited directly on the surface of an LLZO SSE and allowed to cool down to room temperature to give a multilayer according to the present invention. The cover material layer was then brought into contact with the anode layer, and the resulting complex was assembled together with a LiFePO₄ (LFP) cathode commercial LFP laminate (LFP, loading: 2.0 mAh·cm⁻² and specific capacity: 150 mAh·g⁻¹ , active material: 83%, from Customcells GmbH) to yield a cell according to the invention.

### Example 2—Conductivity Tests

The conductivity of the multilayer of Example 1 was measured by Electrochemical Impedance Spectroscopy (EIS) and compared to cells comprising other SSEs. The results are depicted in the table below.

| | Conductivity (S · cm⁻¹) at |
|---|---|
| Soft material | 25° C. |
| Polymer [PEO] + LiTFSI | 9 · 10⁻⁶ |
| Ceramic-Polymer [PEO] + | 8 · 10⁻⁶ |
| LiTFSI composite | |
| Example 1 | 1.0-2.0 · 10⁻³ |

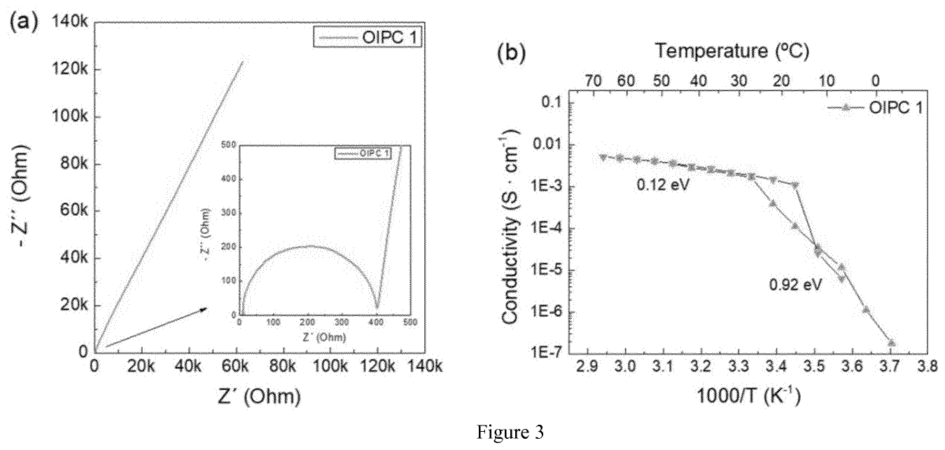

The results demonstrate an excellent improvement in conductivity for the multilayer according to the present invention. Corresponding EIS and Arrhenius plots are shown in FIG. 3.

Furthermore, it was confirmed that the area specific resistance (ASR) as measured at room temperature was reduced from 640 to 130 Ω·cm², about five times lower, in the multilayer of Example 1 as compared to the same SSE without the cover material. The conductivity of Example 1 was also confirmed to be superior to the same SSE without the cover material at both room temperature and 70° C.

### Example 3—Stripping/Plating Tests

Li stripping/plating experiments were performed at various current densities for 5 cycles with steps of 2 h in order to evaluate the impact of disposing the cover material described in Example 1 between the electrolyte and Li metal during galvanostatic cycling. Prior to testing, the cells were conditioned at 70° C. for 24 h to ensure good contact at the cover material interface.

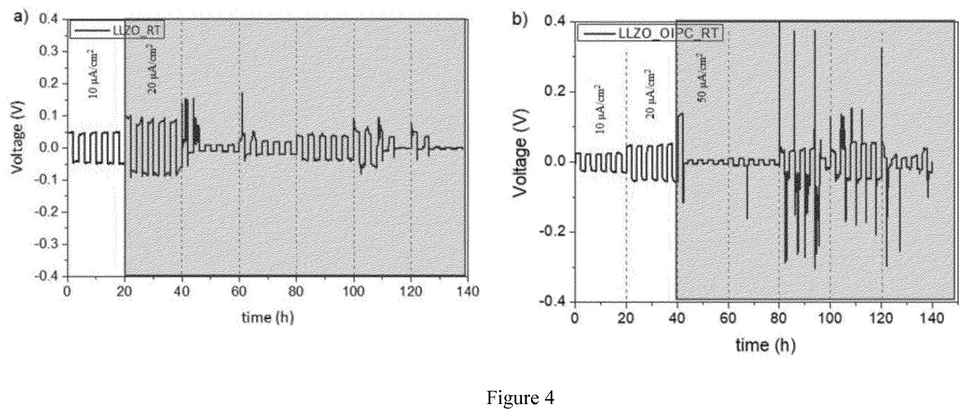

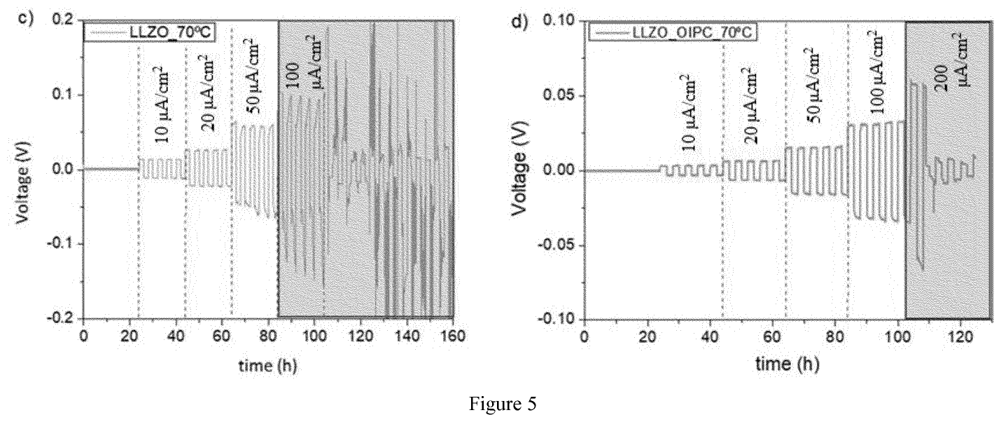

FIGS. 4 and 5 show the results. With the addition of the cover material, the cell was able to withstand up to one critical current density higher (the double) than without the cover material, at both temperatures tested, namely room temperature and 70° C. In particular, the multilayer of the invention was able to prevent the short-circuit up to 200 μA/cm² at 70° C., and up to 50 μA/cm² at room temperature.

1. A multilayer comprising:
An anode layer, which presents a surface that faces a solid electrolyte layer;
The solid electrolyte layer, which presents a surface that faces the anode layer; and
A cover material layer disposed between and in contact with said surface of the anode layer and said surface of the solid electrolyte layer;
wherein the cover material comprises at least one organic ionic plastic crystal (OIPC).

2. The multilayer according to claim 1, wherein the OIPC comprises a cation selected from:
a) an ammonium cation (NR₄⁺), a phosphonium cation (PR₄⁺), or a sulfonium cation (SR₃⁺)
wherein each R is independently hydrogen; a C₁-C₃₀, preferably C₁-C₆ alkyl group; a C₂-C₃₀, preferably C₂-C₆ alkenyl group; or a C₂-C₃₀, preferably C₂-C₆ alkynyl group;
wherein the alkyl, alkenyl or alkynyl groups may be unsubstituted or substituted with halogen or hydroxyl;
and wherein the alkyl, alkenyl or alkynyl groups may be branched or linear; or
b) a heterocycle which bears a positive charge at any of its heteroatoms.

3. The multilayer according to claim 1, wherein the OIPC comprises an anion selected from BF₄⁻, PF₆⁻, SCN⁻, I⁻, nitrate, phosphate, or a sulfonylimide or sulfonate of the following formula: 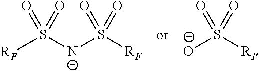
wherein each R_{f} is independently F; a C₁-C₃₀, preferably C₁-C₆ alkyl group; a C₂-C₃₀, preferably C₂-C₆ alkenyl group; or a C₂-C₃₀, preferably C₂-C₆ alkynyl group; wherein the alkyl, alkenyl or alkynyl groups are fully or partially substituted with F;
and wherein the alkyl, alkenyl or alkynyl groups may be branched or linear.

4. The multilayer according to claim 1, wherein the OIPC is present in an amount of more than 50% by weight with respect to the total weight of the cover material.

5. The multilayer according to claim 4, wherein the OIPC is present in an amount of more than 90% by weight with respect to the total weight of the cover material.

6. The multilayer according to claim 1, wherein the cover material further comprises at least one additional component selected from ionic liquids, polymers, dopants and inorganic fillers.

7. The multilayer according to claim 5, wherein the cover material consists of the OIPC.

8. The multilayer according to claim 1, wherein the cover material comprises no polymer.

9. The multilayer according to claim 1, wherein the cover material comprises no solvent.

10. The multilayer according to claim 1, wherein the anode is selected from Na, Li, Zn, Mg, Al, and alloys thereof; Si-based anodes; or hexagonally or rhombohedrally packed carbon materials.

11. The multilayer according to claim 1, wherein the solid electrolyte is selected from garnets, perovskites, argyrodites, sulfides, hydrides, halides, NASICONs, LISICONs, borates, and phosphates.

12. A method for preparing a multilayer as defined in claim 1, the method comprising the steps of:
i. heating a cover material, wherein the cover material comprises at least one organic ionic plastic crystal (OIPC), wherein the heating is to or above the melting point of the OIPC;
ii. depositing the melted cover material on a surface selected from the surface of an anode layer or the surface of a solid electrolyte layer, or on both said surfaces; then
iii. if step ii. involved depositing the melted cover material on only one of the surfaces, bringing the deposited OIPC into contact with the other surface.

13. The method according to claim 12, wherein the method is carried out in the absence of solvent.

14. The method according to claim 12, wherein the depositing is carried out by spin coating, spray coating, screen printing, dip coating or inkjet printing.

15. An electrochemical cell or a battery comprising a multilayer as defined in claim 1.
